(19) United States
(12) Patent Application Publication
(10) Pub. No.: US 2017/0094200 A1
(43) Pub. Date: Mar. 30, 2017

(54) IMAGE PROCESSING APPARATUS AND POSITIONING SYSTEM

(71) Applicant: HITACHI, LTD., Tokyo (JP)

(72) Inventors: Takashi SAEGUSA, Tokyo (JP); Kiyoto ITO, Tokyo (JP); Toyokazu TAKAGI, Tokyo (JP); Tomohiro INOUE, Tokyo (JP)

(73) Assignee: HITACHI, LTD., Tokyo (JP)

(21) Appl. No.: 15/312,029

(22) PCT Filed: May 21, 2014
(86) PCT No.: PCT/JP2014/063401

§ 371 Date: Nov. 17, 2016

(51) Int. Cl. H04N 5/351; G06T 7/62; G06T 7/20; H04N 5/232

(52) U.S. Cl. CPC H04N 5/351; H04N 5/23229; G06T 7/62; G06T 7/20; G06T 2207/30201; G06T 2207/10016

(57) ABSTRACT

An image processing apparatus performs fast image transfer of an image sensor and can easily satisfy required performance of image transfer. The image processing apparatus includes a sensor and a processing unit, the sensor obtains a first image including a recognition target at a first time, obtains a second image including the recognition target at a second time later than the first time, and obtains a third image including the recognition target at a third time later than the second time, and the processing unit determines first setting information of the sensor from the first image and the second image so as to satisfy a predetermined condition when the third image is obtained. Furthermore, the first setting information includes a dimension of the third image and a frame rate at the time of obtaining the third image.

### TECHNICAL FIELD

The present invention relates to an image processing apparatus and a positioning system which are connected to image sensors and perform recognition processing of images which are acquired from the image sensors.

### BACKGROUND ART

Recently, in an image processing apparatus, a method for performing image processing of only a required partial region of the entire region of an image has been used to increase a speed of the image processing necessary for distinguishing a specific object included in an image or for computing a physical amount such as a position or a size of the specific object included in the image.

For example, a technology described in PTL 1 is disclosed as a technology in the related art.

In the technology described in PTL 1, a face of the subject is detected from a plurality of pieces of image data, the amount of correction for the amount of change and a movement amount is computed by detecting the amount of change of a size of the face and the movement amount in horizontal/vertical directions, and a position or a size of an organ (mouth, nose, or the like) of the face in the image data is corrected, based on the amount of correction.

### CITATION LIST

### Patent Literature

PTL 1: JP-A-2012-198807

### SUMMARY OF INVENTION

### Technical Problem

The following description is for easy understanding by those skilled in the art, and is not intended to limit interpretation of the present invention.

In the technology described in PTL 1, performance setting of an image which is transferred to the image sensor is not assumed, and thus, it is difficult to increase a speed of image transfer from an image sensor.

In addition, in the technology described in PTL 1, a position and a size of the image are determined by only a movement amount or the amount of change of a recognition target, and thus, it is difficult to change the size of the image or the position of the image such that required performance of image transfer is satisfied.

The present invention is to solve at least one of increasing a speed of image transfer and satisfying required performance of the image transfer in image recognition, which are described above.

### Solution to Problem

The present invention includes at least one of, for example, the following aspects.

(1) The present invention obtains acquisition conditions (for example, at least one of a dimension and a frame rate) of an image which is acquired by considering required performance.

(2) The present invention predicts a trajectory of a recognition target from the obtained image, and obtains the acquisition conditions of the image by considering the prediction results and the required performance.

(3) The present invention changes a position, a size, and the number of gradations of an image which is transferred from the image sensor by setting the position, the size, and the number of gradations in the image sensor itself, and thereby the speed of the image transfer increases.

(4) The present invention provides an image processing apparatus which can easily change the position, the size, and the number of gradations of the image which is transferred from the image sensor such that the required performance of the image transfer is satisfied.

### Advantageous Effects of Invention

The present invention achieves at least one of the following effects. (1) Since a position, a size, and the number of gradations of an image which is transferred from an image sensor can be changed and the amount of data which is transferred from the image sensor can be reduced, it is possible to increase a speed of image transfer. (2) Since required performance of the image transfer can be satisfied and automatic setting in the image sensor can be performed, it is possible to control a speed of the image transfer easily and flexibly.

### BRIEF DESCRIPTION OF DRAWINGS

FIG. 1 is a diagram illustrating an application example of an image processing apparatus to a positioning device according to the present embodiment.

FIG. 2 is a configuration diagram of the image processing apparatus according to the present embodiment.

FIG. 3 is a flowchart illustrating a processing operation of the image processing apparatus according to the present embodiment.

FIG. 4 is a diagram illustrating an image with a maximum size which is consecutively transferred to the image processing apparatus according to the present embodiment.

FIG. 5 is a diagram illustrating recognition processing of the image processing apparatus according to the present embodiment.

FIG. 6 is a diagram illustrating an example of an image which is consecutively transferred to the image processing apparatus according to the present embodiment.

FIG. 7 is a diagram illustrating a setting screen of the image processing apparatus according to the present embodiment.

FIG. 8 is a diagram illustrating a second embodiment of a component mounting apparatus according to the present embodiment.

FIG. 9 is a diagram illustrating Expression 1 to Expression 4.

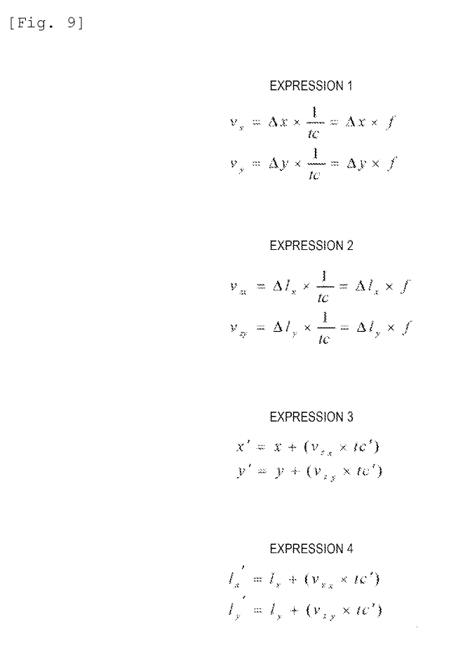

FIG. 10 is a diagram illustrating Expression 5 to Expression 10.

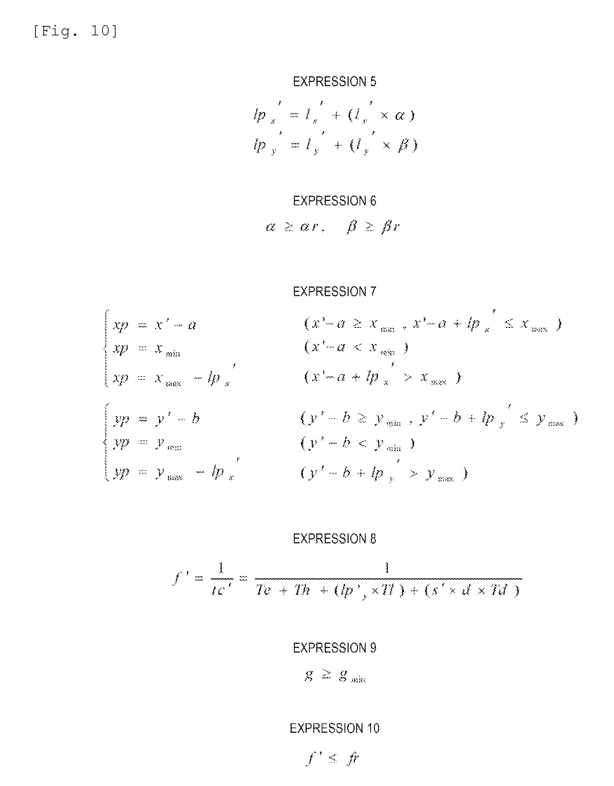

### DESCRIPTION OF EMBODIMENTS

Next, a form (referred to as “embodiment”) to be realized according to the present invention will be described in detail with reference to the suitable drawings. In the following embodiment, a working unit in which an image sensor is mounted is driven, and the embodiment will be described as an application example of a positioning device which positions a recognition target.

Here, in each embodiment (each drawing), a direction of each of an X-axis and a Y-axis is parallel with a horizontal direction, and the X-axis and the Y-axis form an orthogonal coordinate system on a plane along the horizontal direction. In addition, an XY-axis system denotes the X-axis system and the Y-axis system on a plane parallel with the horizontal direction. A relationship between the X-axis and the Y-axis may be replaced with each other. In addition, in each embodiment (each drawing), a direction of a Z-axis is a perpendicular direction, and a Z-axis system denotes an X-axis system on a plane parallel with a perpendicular direction.

### Embodiment 1

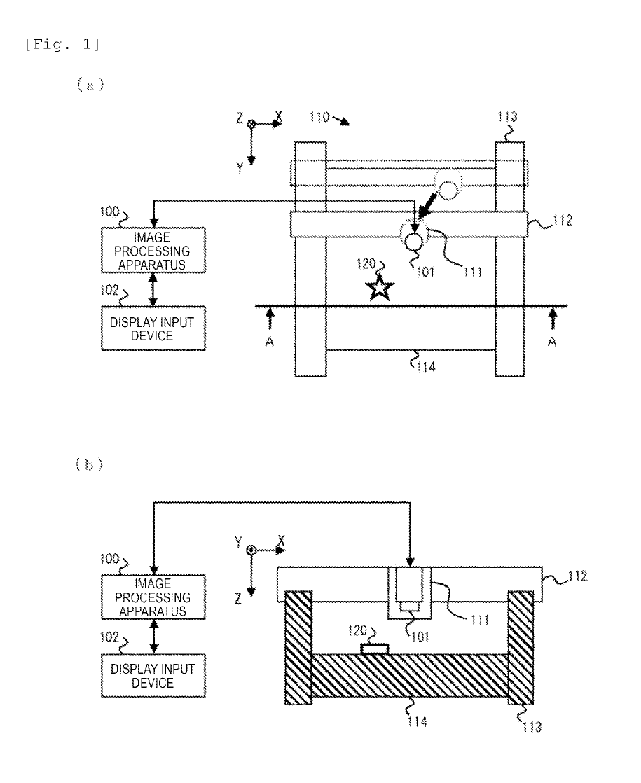

FIG. 1 is a diagram illustrating an application example of an image processing apparatus 100 to a positioning device 110 according to the present embodiment. FIG. 1(a) illustrates a top view of the positioning device 110, and FIG. 1(b) is a cross-sectional view illustrating a structure taken along line A-A illustrated in FIG. 1(a).

The image processing apparatus 100 is connected to an image sensor 101 and a display input device 102.

The positioning device 110 includes the image sensor 101, a positioning head 111, a beam 112, a stand 113, and a base 114.

A recognition target is mounted on the base 114. The image sensor 101 is mounted in the positioning head 111 and the positioning head moves in an X-axis direction. The positioning head 111 is mounted in the beam 112, and the beam 112 moves in a Y-axis direction. The stand 113 supports the beam 112.

The positioning device 110 moves the positioning head 111 in the XY direction, and performs a positioning operation with respect to a recognition target 120.

Accordingly, the recognition target 120 which is imaged by the image sensor 101 moves in a direction opposite to a drive direction of the positioning operation of the positioning head 111, in a plurality of consecutive images whose imaging times are different from each other.

In addition, the recognition target 120 which is imaged by the image sensor 101 moves at the same speed as a drive speed of the positioning head 111, in the plurality of consecutive images whose imaging times are different from each other.

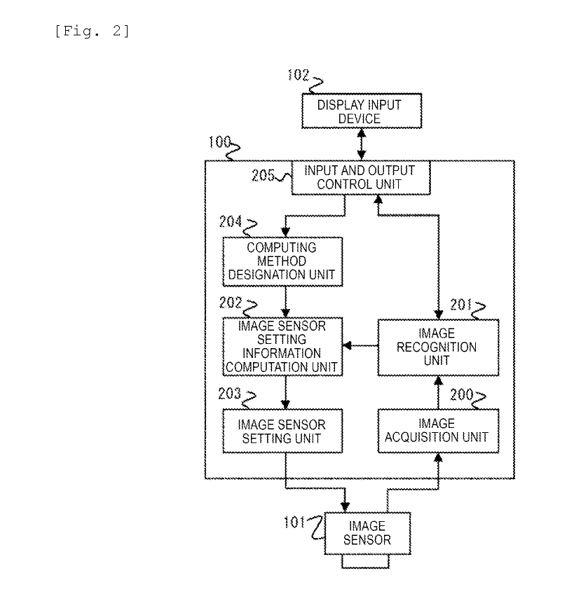

FIG. 2 is a configuration diagram of the image processing apparatus 100 according to the present embodiment.

The image processing apparatus 100 includes an image acquisition unit 200, an image recognition unit 201, an image sensor setting unit 203, an image sensor setting information computation unit 202, a computing method designation unit 204, and an input and output control unit 205.

The image acquisition unit 200 acquires images which are captured by the image sensor 101 and are transferred from the image sensor 101.

The image recognition unit 201 is connected to the image acquisition unit 200, and performs recognition processing to recognize the recognition target 120 from the plurality of consecutive images whose imaging times are different from each other and which are acquired by the image acquisition unit 200, using a computing method that is previously designated.

The image sensor setting information computation unit 202 is connected to the image recognition unit 201, and computes setting information which is transferred to the image sensor 101 so as to satisfy required performance of a frame rate that is previously designated, based on recognition results of the image recognition unit 201 and the computing method that is previously designated.

The image sensor setting unit 203 transfers the setting information which is computed by the image sensor setting information computation unit 202 to the image sensor 101, and performs setting.

The computing method designation unit 204 designates the setting information or the like of the performance requirements of the frame rate, or the computing method to the image sensor setting information computation unit 202.

The input and output control unit 205 inputs a computing method or execution command of computation processing to the image recognition unit 201 and the computing method designation unit 204, and outputs a set computing method or computation results to the image recognition unit 201 and the computing method designation unit 204.

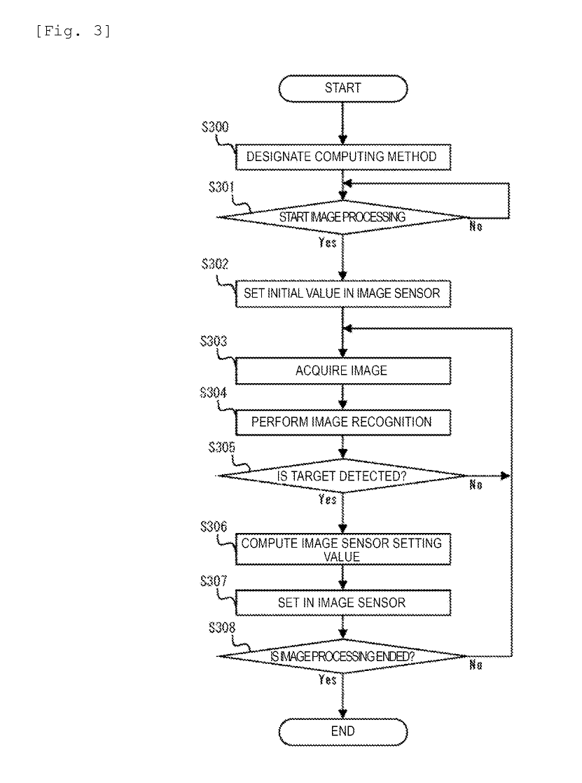

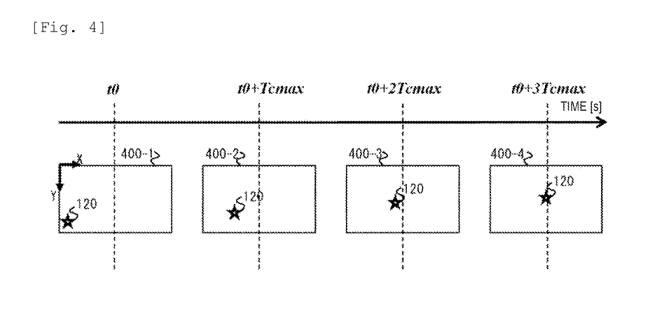

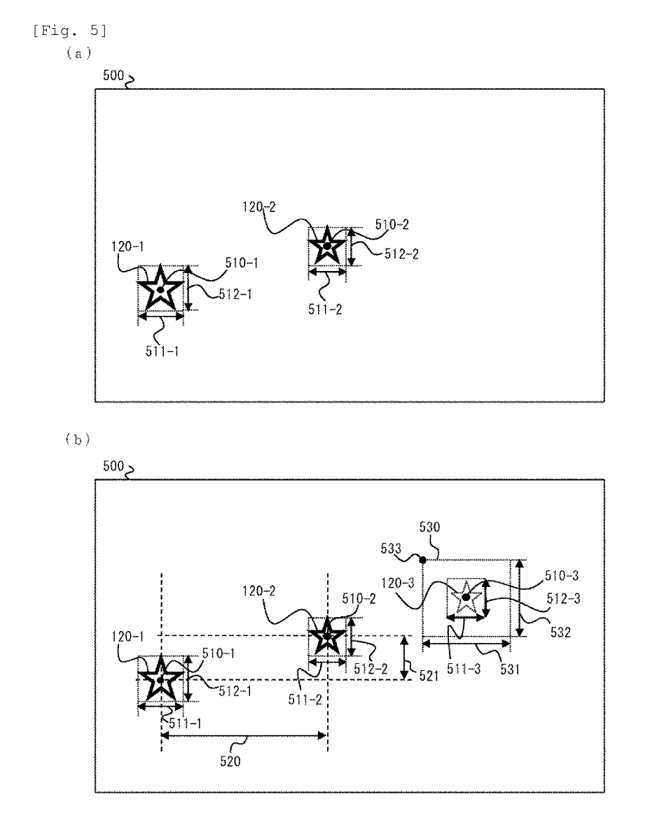

Next, a processing operation of the image processing apparatus 100 will be described with reference to FIG. 3, FIG. 4, and FIG. 5. FIG. 3 is a flowchart illustrating the processing operation of the image processing apparatus 100 according to the present embodiment.

The image processing apparatus 100 first designates the computing method to the computing method designation unit 204 through the display input device 102 which is connected to the input and output control unit 205 (S300). At this time, the computing method which is designated to the computing method designation unit 204 includes the following items (1) to (7). (1) A required value of the frame rate of the image which is transferred from the image sensor 101 (2) a lower limit value of a surplus size ratio in the X-direction of the image which is transferred from the image sensor 101 (3) a lower limit value of a surplus size ratio in the Y-direction of the image which is transferred from the image sensor 101 (4) changing or unchanging of a center position of the image which is transferred from the image sensor 101 (5) a plurality of types of computation condition information which are configured by changing or unchanging of gradation of the image which is transferred from the image sensor 101 (6) an initial value of each computation condition information (7) computation applicable condition information which is configured by applicable conditions of each computation condition information.

Subsequently, in S301, the image processing apparatus 100 determines whether or not to start the image processing. For example, in a case where start of the image processing is commanded to the computing method designation unit 204 through the display input device 102 which is connected to the input and output control unit 205, the image processing apparatus 100 starts the image processing (S301→Yes). In a case where answer is No in the processing of S301, the image processing apparatus 100 waits for start designation of the image processing.

If start of the image processing is determined, a predetermined initial value is set in the image sensor 101, based on the computation applicable condition information which is set in the computing method designation unit 204 (S302).

Subsequently, the image acquisition unit 200 acquires the image which is transferred from the image sensor 101 (S303).

Here, an example of the image which is transferred from the image sensor 101 to the image processing apparatus 100 in S303 will be described with reference to FIG. 4.

FIG. 4 is a diagram illustrating an image with a maximum size which is consecutively transferred to the image processing apparatus 100 according to the present embodiment. A coordinate system of the image which is transferred from the image sensor 101 is the same as the coordinate system illustrated in FIG. 1.

Entire region images 400-1 to 400-4 which are images with a maximum size that are transferred from the image sensor 101 are obtained by imaging the recognition target 120 and are transferred to the image processing apparatus 100 at a unique frame rate Fₘₐₓ [fps].

Accordingly, if imaging time of the entire region image 400-1 is referred to as t0 [s], time between imaging times of each of the entire region images 400-1 to 400-4 is referred to as Tcₘₐₓ [s] (=1/Fₘₐₓ), the imaging time of the entire region image 400-2 can be represented by t0+Tcₘₐₓ [s], the imaging time of the entire region image 400-3 can be represented by t0+2×Tcₘₐₓ [s], and the imaging time of the entire region image 400-4 can be represented by t0+3×Tcₘₐₓ [s].

At this time, the recognition target 120 which is captured as the entire region images 400-1 to 400-4 moves in a direction opposite to the drive direction of the positioning operation of the positioning head 111.

Accordingly, as illustrated in the entire region images 400-1 to 400-4, the recognition target 120 moves from lower left of the entire region image 400-1 to the center of the entire region image 400-4 and stops, while imaging time passes.

Herefrom, the processing operation of the image processing apparatus 100 will be described from the processing of S303 in the flowchart illustrated in FIG. 3.

After processing of S303 is performed, the image processing apparatus 100 transfers an image that is obtained by the image acquisition unit 200 to the image recognition unit 201, and the image recognition unit 201 performs recognition processing of the image (S304).

Here, content of the recognition processing which is performed in S304 will be described with reference to FIG. 5(a). Here, the frame rate of the image which is transferred from the image sensor 101 is referred to as f [fps], and the time between imaging times of the consecutive images which are transferred from the image sensor 101 is referred to as tc [s] (=1/f), and an image which is obtained by superimposing an image captured at a certain time t [s] onto an image captured at capturing time t−tc [s] before the image by one is referred to as a superimposed image 500. An image captured at time t−tc [s] can be referred to as a first image, an image captured at time t [s] can be referred to as a second image, and an image captured at time after the time t [s] can be referred to as a third image.

For the sake of convenience of description of the superimposed image 500 illustrated in FIG. 5, -1 is attached to the end of a reference numeral of an object or numeric value which is recognized by the image captured at the time t−tc (for example, recognition target 120-1), and -2 is attached to the end of a reference numeral of an object or numeric value which is recognized by the image captured at the time t (for example, recognition target 120-2).

If an image is transferred from the image sensor 101, the image recognition unit 201 recognizes whether or not the recognition targets 120-1 and 120-2 exist. In addition, in a case where the recognition targets 120-1 and 120-2 exist, the following items (1) to (3) are recognized.

(1) central coordinates 510-1 and 510-2 which are positions of the centers of the recognition targets 120-1 and 120-2 in the image, (2) X-axis sizes 511-1 and 511-2 which are sizes in the X-axis direction of the recognition targets 120-1 and 120-2, and (3) Y-axis sizes 512-1 and 512-2 which are sizes in the Y-axis direction of the recognition targets 120-1 and 120-2.

Here, the existence and unexistence of the recognition targets 120-1 and 120-2 and the central coordinates 510-1 and 511-2 are recognized by a general image processing method of pattern matching or the like.

In addition, the image recognition unit 201 computes a minimum gradation number gₘᵢₙ, which is a minimum necessary for the recognition processing, of brightness of the captured image of the image sensor 101, from brightness values of the recognition targets 120-1 and 120-2 of the superimposed image 500, and brightness values of a background image other than the recognition targets 120-1 and 120-2 of the superimposed image 500.

Subsequently, the image recognition unit 201 transfers the central coordinates 510-1 and 510-2, the X-axis sizes 511-1 and 511-2, the Y-axis sizes 512-1 and 512-2, and the minimum gradation numbers gₘᵢₙ, which are obtained in the aforementioned processing, to the image sensor setting information computation unit 202, and ends the processing.

Herefrom, the processing operation of the image processing apparatus 100 will be described from the processing of S305 in the flowchart illustrated in FIG. 3.

In a case where the recognition target 120 is detected from results of the image recognition of the image recognition unit 201 (S305→Yes), the image processing apparatus 100 computes a setting value which is transferred to the image sensor 101 by the processing of the image sensor setting information computation unit 202, based on one piece of computation condition information which coincides with computation applicable condition information that is designated to the computing method designation unit in S300, and results of the image recognition which is computed in S304 (S306). In a case where answer is No in the processing of S305, the image processing apparatus 100 does not change the setting value of the image sensor 101, the image acquisition unit 200 acquires the image of the next time which is transferred from the image sensor 101 (S303), and the processing is repeated.

Here, processing content of the image sensor setting information computation unit 202 will be described with reference to FIG. 5(b).

The image sensor setting information computation unit 202 computes an X-axis movement amount 520 which is the amount of movement from the recognition target 120-1 to the recognition target 120-2 in the X-axis direction, and an Y-axis movement amount 521 which is the amount of movement from the recognition target 120-1 to the recognition target 120-2 in the Y-axis direction, based on the central coordinates 510-1 and 510-2 which are transferred from the image recognition unit 201.

Here, the central coordinates 510-1 is referred to as (x0, y0), the central coordinates 510-2 is referred to as (x, y), the X-axis movement amount 520 is referred to as Δx (=x−x0), and the Y-axis movement amount 521 is referred to as Δy (=y−y0).

At this time, a speed vₓ [pixel/s] from the recognition target 120-1 to the recognition target 120-2 in the X-axis direction, and a speed v_{y} [pixel/s] from the recognition target 120-1 to the recognition target 120-2 in the Y-axis direction are obtained by using Expression 1.

A speed of the recognition target 120 in the X-axis direction and a speed of the recognition target 120 in Y-axis direction may be obtained by using a general image processing method such as optical flow.

Furthermore, the X-axis size 511-1 is referred to as lx0, the X-axis size 511-2 is referred to as lx, the Y-axis size 512-1 is referred to as ly0, the Y-axis size 512-2 is referred to as ly, the amount of change of the size of the recognition target in X-axis direction is referred to as Δlx (=lx−lx0), and the amount of change of the size of the recognition target in Y-axis direction is referred to as Δly (=ly−ly0).

In addition, among speeds from the recognition target 120-1 to the recognition target 120-2 in Z-axis direction, the speed acting in the X-axis direction is referred to as X-axis size changeability v_{zx} [pixel/s], and the speed acting in the Y-axis direction is referred to as Y-axis size changeability v_{zy} [pixel/s].

At this time, the image sensor setting information computation unit 202 computes the X-axis size changeability v_{zx} and the Y-axis size changeability v_{z}, using Expression 2.

The X-axis size changeability and the Y-axis size changeability may be obtained by using another general image processing method such as stereovision.

Subsequently, the image sensor setting information computation unit 202 computes recognition results, which are predicted, of a recognition target 120-3 that is imaged by the image sensor 101 at a time next to an imaging time t of the imaging sensor from the following items (1) to ( ) which are computed by using the recognition targets 120-1 and 120-2. (1) Speed vₓ in the X-axis direction, (2) speed v_{y} in the Y-axis direction, (3) the X-axis size changeability v_{zx}, and (4) the Y-axis size changeability v_{zy}.

Here, a frame rate when an image captured at a time next to the time t in which the image sensor 101 captures an image is transferred is referred to as f′ [fps], a time from the time when the image sensor 101 captures an image at the time t to the next time when the image sensor captures another image is referred to as tc′ [s] (=1/f′), and a predicted position of the recognition target 120-3 which is imaged at an imaging time t+tc′ is denoted by a dashed line in FIG. 5(b).

In FIG. 5(b), -3 is attached to the end of conformity of the recognition results which are predicted in the image at a time t+tc′ (for example, recognition target 120-3).

The image sensor setting information computation unit 202 first computes the following items (1) to (3) as prediction values of the recognition results of the capture image at the time t+tc′. (1) Central coordinates 510-3 in a coordinate system of the superimposed image 500 of the recognition target 120-3, (2) an X-axis size 511-3 of the recognition target 120-3, and (3) an Y-axis size 512-3 of the recognition target 120-3.

At this time, if the central coordinates 510-3 of the recognition target 120-3 which are predicted are referred to as (x′, y′), the image sensor setting information computation unit 202 computes the central coordinates 510-3 using Expression 3.

Subsequently, if the X-axis size 511-3 of the recognition target 120-3 which is predicted is referred to as lₓ′ and the Y-axis size 512-3 of the recognition target 120-3 which is predicted is referred to as l_{y}′, the image sensor setting information computation unit 202 computes each of the X-axis size 511-3 and the Y-axis size 512-3, using Expression 4.

Subsequently, the image sensor setting information computation unit 202 obtains image sensor setting information ((1) to (5), can be referred to as first setting information) which satisfies computation condition information (can be referred to as a predetermined condition or a required value) that is configured by the following items (a) to (c), based on the central coordinates 510-3, the X-axis size 511-3, and the Y-axis size 512-3 which are computed by the image sensor setting information computation unit. (a) A required value fr [fps] of the frame rate, (b) a lower limit value αr [%] of a surplus size ratio in the X-axis direction with respect to the X-axis size 511-3, (c) a lower limit value βr [%] of a surplus size ratio in the Y-axis direction with respect to the Y-axis size 512-3, (1) an X-axis transfer size 531 which is a transfer size of an image that is transferred from the image sensor 101 in the X-axis direction, (2) a Y-axis transfer size 532 which is a transfer size of an image that is transferred from the image sensor 101 in the Y-axis direction, (3) transfer coordinates 533 which are coordinate information for designating a position where an image transferred from the image sensor 101 is transferred as position coordinates of an image with a maximum size, (4) a transfer gradation number g which is the number of gradations of an image which is transferred from the image sensor 101, and (5) a frame rate f′. The X-axis transfer size 531 and the Y-axis transfer size 532 can be represented as a dimension of the third image. In addition, the transfer coordinates 533 can be represented as an example of information which defines a position of the third image.

Here, the X-axis transfer size 531 is referred to as lpₓ′, the Y-axis transfer size 532 is referred to as lp_{y}′, a surplus size ratio in the X-axis direction with respect to the X-axis size 511-3 is referred to as an X-axis surplus size ratio α [%], and a surplus size ratio in the Y-axis direction with respect to the Y-axis size 512-3 is referred to as a Y-axis surplus size ratio β [%]. lpₓ′ can be represented as a dimension in the first direction, and lp_{y}′ can be represented as a second dimension in a direction orthogonal to the first direction. α and β can be represented as predetermined coefficients.

The image sensor setting information computation unit 202 first computes each of the X-axis transfer size 531 and the Y-axis transfer size 532, using Expression 5. Here, the X-axis surplus size ratio α and the Y-axis surplus size ratio β are set as values which satisfy Expression 6.

Here, minimum vales of coordinates which can be set in an image that is transferred from the image sensor 101 are referred to as (xₘᵢₙ, yₘᵢₙ), maximum vales of coordinates which can be set in an image that is transferred from the image sensor 101 are referred to as (xₘₐₓ, yₘₐₓ), and the transfer coordinates 533 are referred to as (xp, yp).

The image sensor setting information computation unit 202 computes the transfer coordinates 533, using Expression 7. Here, it is assumed that variables a and b in Expression 7 are arbitrary unique values which respectively satisfy (lₓ′/2)≦a≦lpₓ′−(lₓ′/2) and (l_{y}′/2)≦b≦lp_{y}′−(l_{y}′/2).

FIG. 5(b) illustrates an example of a case where a=(lp_{y}′/2) and b=(lp_{y}′/2). Here, furthermore, an image transfer size 530 in a case of the X-axis transfer size 531 and the Y-axis transfer size 532 which are computed is referred to as s′ [pixel] (=lpₓ′×lp_{y}′), an exposure time of the image sensor 101 is referred to as Te [s], a transfer time of a head portion during image transfer of the image sensor 101 is referred to as Th [s], a transfer time which increases during transfer of one line of the image sensor 101 is referred to as Tl [s], a transfer time per one bit of a pixel value of the image sensor 101 is referred to as Td [bps], and the number of bits of gradation values which are set in the image sensor 101 is referred to as d [bit] (=ceil (log₂g)) (ceil is a ceil function). Te, Th, Tl, d, and Td can be referred to as second setting information.

The image sensor setting information computation unit 202 computes the frame rate f′ at this time, using Expression 8. Here, it is assumed that the transfer gradation function g is a value which satisfies Expression 9.

In addition, the image sensor setting information computation unit 202 deviates equations which are represented in Expression 3 to Expression 9, and satisfies Expression 10, thereby computing the image sensor setting information, while satisfying the computation condition information.

At this time, the image sensor setting information computation unit 202 requires computation procedure for adjusting values of the X-axis surplus size ratio α, the Y-axis surplus size ratio β, and the transfer gradation number g, and computes the image sensor setting information, so as to satisfy conditions represented in Expression 9.

It is considered that, if initial values of each parameter are set as tc′=1/fr, α=αr, β=βr, and g=gₘᵢₙ, f′ is computed, and thereby conditions of Expression 8 are satisfied, a method or the like for increasing α, β, and g so as to approach f′=fr is used, as an example of the computation procedure of the image sensor setting information computation unit 202.

A general optimization computing method may be applied to the computation procedure of the image sensor setting information computation unit 202.

Finally, the image sensor setting information computation unit 202 transfers the computed image sensor setting information to the image sensor setting unit 203, and completes the processing of S306.

Herefrom, the processing operation of the image processing apparatus 100 will be described from the processing of S307 in the flowchart illustrated in FIG. 3.

After S306 is processed, the image sensor setting unit 203 of the image processing apparatus 100 sets the image sensor setting information which is transferred from the image sensor setting information computation unit 202, in the image sensor 101 (S307).

Subsequently, the image processing apparatus 100 ends the processing, in a case where end of the image processing is commanded to the computing method designation unit 204 through the display input device 102 which is connected to the input and output control unit 205 (S308→Yes). If answer is No in processing of S308, the image acquisition unit 200 acquires an image at a time next to the time when an image is transferred from the image sensor 101 (S303), and the processing is repeated.

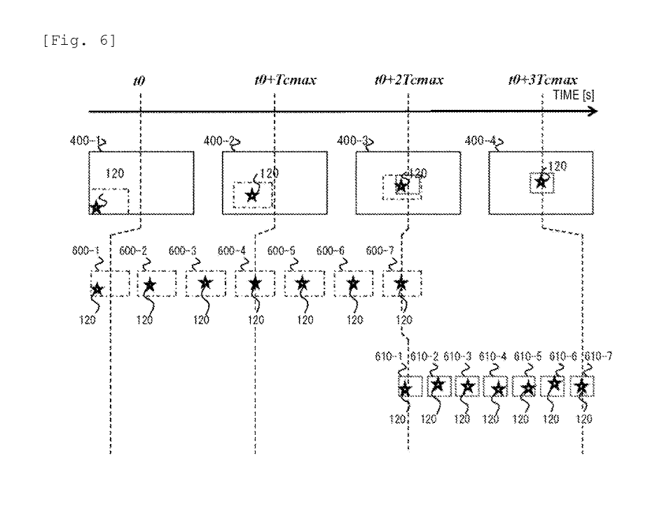

FIG. 6 is a diagram illustrating an example of the image which is consecutively transferred to the image processing apparatus 100 according to the present embodiment.

First partially acquired images 600-1 to 600-7 are images in which only partial regions of the entire region images 400-1 to 400-4 are transferred from the image sensor 101, and the frame rate is approximately triple the frame rate of the entire region images 400-1 to 400-4 in the example of FIG. 6.

Second partially acquired images 610-1 to 610-7 are images in which only partial regions of the entire region images 400-1 to 400-4 are transferred from the image sensor 101, and the frame rate is approximately sextuple the frame rate of the entire region images 400-1 to 400-4, and is approximately triple the first partially acquired images 600-1 to 600-7, in the example of FIG. 6.

Accordingly, the second partially acquired images 610-1 to 610-7 are smaller in a size of a transferred image than the first partially acquired images 600-1 to 600-7.

It is preferable that the entire region image 400-1 is applied to the image processing apparatus 100 which is applied to the positioning device 110 according to the present embodiment so as to find the recognition target 120 over a wide area, when a distance between the positioning head 111 to which the image sensor 101 is mounted and the recognition target 120 is far, as illustrated in FIG. 6. In addition, as a distance between the positioning head 111 and the recognition target 120 is close and the positioning head 111 is decelerated, in order to recognize a vibrational error of the positioning head 111, it is preferable that setting of the image sensor 101 is switched and the image transferred from the image sensor 101 is changed to the first partially acquired images 600-1 to 600-7 or the second partially acquired images 610-1 to 610-7, and thereby the frame rate is increased.

As a specific example, in a case where the positioning device 110 according to the present embodiment is a component mounting apparatus in which an electronic component having a short side with a size of several hundred μm is mounted on a printed wiring board, it is preferable that an image size of each of the entire region images 400-1 to 400-4 is approximately 10 to 20 mm in both the X-axis direction and Y-axis direction, the frame rate is approximately 100 to 200 fps at that time, an image size of each of the first partially acquired image 600-1 to 600-7 is approximately 3 to 6 mm in both the X-axis direction and Y-axis direction, the frame rate is approximately 300 to 600 fps at that time, an image size of each of the second partially acquired image 610-1 to 610-7 is approximately 1 to 3 mm, and the frame rate is approximately 1000 fps at that time.

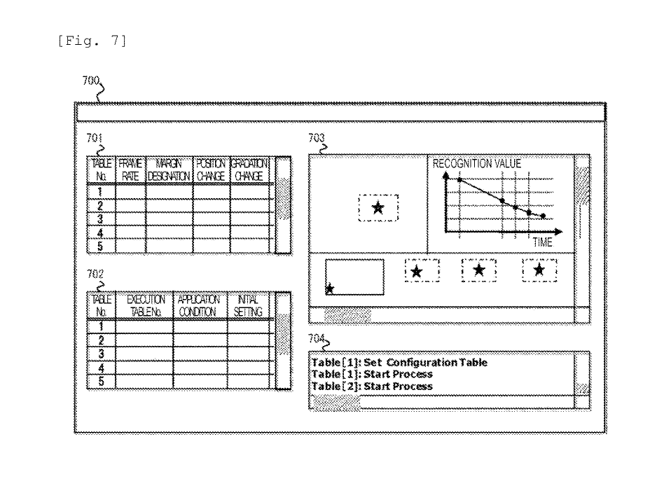

FIG. 7 is a diagram illustrating a setting screen 700 of the image processing apparatus 100 according to the present embodiment.

The setting screen 700 is configured with a parameter setting unit 701, a parameter application condition setting unit 702, an image processing result display unit 703, and a processing content display unit 704.

The parameter setting unit 701 is an input interface for setting computation condition information.

The parameter application condition setting unit 702 is an input interface for setting computation application condition information with respect to a plurality of types of computation condition information.

The image processing result display unit 703 is an output interface for displaying processing results of the image recognition unit 201 and the image sensor setting information computation unit 202 of the image processing apparatus 100, based on the computation condition information which is set by the parameter setting unit 701 and the computation application condition information which is set by the parameter application condition setting unit 702.

In addition, specifically, the image processing result display unit 703 performs displaying of the latest image which is obtained from the image sensor 101, displaying of a recognition value of the recognition target 120, displaying of time history of an image which is transferred from the image sensor 101, or the like.

The processing content display unit 704 is an output interface for displaying progress or the like of internal processing of the image processing apparatus 100.

A user of the image processing apparatus 100 first performs setting of the computation condition information of the parameter setting unit 701, and setting of the computation application condition information of the parameter application condition setting unit 702. Subsequently, the image processing apparatus confirms whether or not a desired recognition processing is performed with reference to the image processing result display unit 703 and the processing content display unit 704, and adjusts the computation condition information and the computation application condition information, based on the confirmed content.

### Embodiment 2

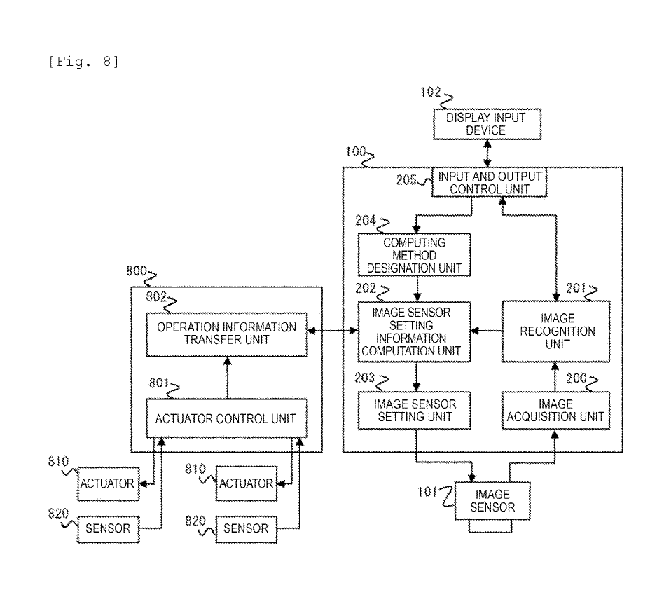

FIG. 8 is a diagram illustrating a second embodiment of the image processing apparatus 100 according to the present embodiment.

A servo control device 800 is configured with an actuator control unit 801 and an operation information transfer unit 802. The servo control device 800 is connected to sensors 820 for feeding back positions, speeds, accelerations, or the like of an actuator 810 and an actuator 810. The actuator control unit 801 controls the actuator 810, based on feedback information of the sensor 820.

In addition, the actuator control unit 801 acquires a current position, a current speed, or the like of a working unit which uses the actuator 810, based on the feedback information of the sensor 820.

Furthermore, the actuator control unit 801 computes a position, a speed, or the like of the working unit that uses the actuator 810 which are predicted at a next imaging time of the image sensor 101, based on a position, a command waveform of a speed, or generation of a trajectory for driving the actuator 810.

The actuator control unit 801 transfers the computed current position or the computed current speed information of the working unit which uses the actuator 810, and the position and the speed information of the working unit that uses the actuator 810 which is predicted at the next imaging time of the image sensor 101 to the operation information transfer unit 802.

In addition, the operation information transfer unit 802 is connected to the image sensor setting information computation unit 202 of the image processing apparatus 100.

Here, the image sensor setting information computation unit 202 of the image processing apparatus 100 according to the present embodiment performs processing by acquiring at least one of the following items (1) to ( ) from the operation information transfer unit 802 of the servo control device 800. (1) A speed of the recognition target 120-2 of a current capturing image in X-axis direction, (2) a speed in Y-axis direction, (3) X-axis size changeability, (4) Y-axis size changeability, (5) the central coordinates 510-3 which are predicted in an image which is captured at the next time, (6) an X-axis size 511-3, and (7) a Y-axis size 511-3.

At this time, the image sensor setting information computation unit 202 acquires information which is not acquired from the operation information transfer unit 802 among the entire information necessary for processing of itself, from the image recognition unit 201 in the same manner as in Embodiment 1.

By configuring the image processing apparatus 100 as described above, computation load of the image recognition unit 201 and the image sensor setting information computation unit 202 can be reduced, and faster image processing can be performed.

In addition, if the image processing apparatus 100 according to the present embodiment is applied to the positioning device 110, the actuator 810 and the sensor 820 are applied to control of the positioning head 111 which is the working unit of the positioning device 110 and control of the beam 112, and furthermore, the servo control device 800 is applied to controls of the actuator 810 and the sensor 820, it is possible to obtain more accurate position or speed than the position or the speed which is computed by the recognition processing of the image processing apparatus 100.

Other effects which are obtained by the component mounting apparatus according to Embodiment 2 are the same as in Embodiment 1, and thus, repeated description thereof will be omitted.

As described above, embodiments according to the present invention are described, and the present invention is not limited to the embodiments. The content described in the present embodiment can also be applied to a vehicle, and a railroad. That is, the positioning system is represented in a broad sense including a component mounting device, a vehicle, a railroad, and other systems.

### REFERENCE SIGNS LIST

100 IMAGE PROCESSING APPARATUS
101 IMAGE SENSOR
102 DISPLAY INPUT DEVICE
110 POSITIONING DEVICE
111 POSITIONING HEAD
112 BEAM
113 STAND
114 BASE
120, 120-1, 120-2, 120-3 RECOGNITION TARGET
200 IMAGE ACQUISITION UNIT
201 IMAGE RECOGNITION UNIT
202 IMAGE SENSOR SETTING INFORMATION COMPUTATION UNIT
203 IMAGE SENSOR SETTING UNIT
204 COMPUTING METHOD DESIGNATION UNIT
205 INPUT AND OUTPUT CONTROL UNIT
400, 400-1 TO 400-4 ENTIRE REGION IMAGE
500 SUPERIMPOSED IMAGE
510-1, 510-2, 510-3 CENTRAL COORDINATES
511-1, 511-2, 511-3 X-AXIS SIZE
512-1, 512-2, 512-3 Y-AXIS SIZE
520 X-AXIS MOVEMENT AMOUNT
521 Y-AXIS MOVEMENT AMOUNT
530 IMAGE TRANSFER SIZE
531 X-AXIS TRANSFER SIZE
532 Y-AXIS TRANSFER SIZE
533 TRANSFER COORDINATES
600-1 TO 600-7 FIRST PARTIALLY ACQUIRED IMAGES
610-1 TO 610-7 SECOND PARTIALLY ACQUIRED IMAGES
700 SETTING IMAGE
701 PARAMETER SETTING UNIT
702 PARAMETER APPLICATION CONDITION SETTING UNIT
703 IMAGE PROCESSING RESULT DISPLAY UNIT
704 PROCESSING CONTENT DISPLAY UNIT
800 SERVO CONTROL DEVICE
801 ACTUATOR CONTROL UNIT
802 OPERATION INFORMATION TRANSFER UNIT
810 ACTUATOR
820 SENSOR

1. An image processing apparatus comprising:
a sensor; and
a processing unit,
wherein the sensor obtains a first image including a recognition target at a first time, obtains a second image including the recognition target at a second time later than the first time, and obtains a third image including the recognition target at a third time later than the second time,
wherein the processing unit determines first setting information of the sensor from the first image and the second image so as to satisfy a predetermined condition when the third image is obtained, and
wherein the first setting information includes a dimension of the third image and a frame rate at the time of obtaining the third image.

2. The image processing apparatus according to claim 1, wherein the processing unit obtains the dimension of the third image, using a predicted value of dimension of the recognition target in the third image and a predetermined coefficient.

3. The image processing apparatus according to claim 2,
wherein the dimension of the third image includes a dimension in a first direction and a second dimension in a direction orthogonal to the first direction, and
wherein the processing unit obtains the frame rate, using the second dimension and second setting information of the sensor.

4. The image processing apparatus according to claim 3, wherein the second setting information includes an exposure time of the sensor, a transfer time of a head portion of the sensor, a transfer time which is increased per line of the sensor, a number of bits of a gradation value of the sensor, and a transfer time per bit of the sensor.

5. The image processing apparatus according to claim 4,
wherein the predetermined condition includes a required value of the frame rate, and
wherein the frame rate is less than the required value.

6. The image processing apparatus according to claim 5, wherein the first predetermined condition includes a lower limit value of the predetermined coefficient.

7. The image processing apparatus according to claim 6, wherein the first setting information includes information that defines a position of the third image.

8. The image processing apparatus according to claim 7, wherein the first setting information includes a number of gradations of the third image.

9. The image processing apparatus according to claim 1,
wherein the dimension of the third image includes a dimension in a first direction and a second dimension in a direction orthogonal to the first direction, and
wherein the processing unit obtains the frame rate, using the second dimension and second setting information of the sensor.

10. The image processing apparatus according to claim 9,
wherein the second setting information includes an exposure time of the sensor, a transfer time of a head portion of the sensor, a transfer time which is increased per line of the sensor, a number of bits of a gradation value of the sensor, and a transfer time per bit of the sensor.

11. The image processing apparatus according to claim 1,
wherein the predetermined condition includes a required value of the frame rate, and
wherein the frame rate is less than the required value.

12. The image processing apparatus according to claim 1, wherein the predetermined condition includes a lower limit value of a predetermined coefficient for obtaining the third image.

13. The image processing apparatus according to claim 1, wherein the first setting information includes information that defines a position of the third image.

14. The image processing apparatus according to claim 1, wherein the first setting information includes a number of gradations of the third image.

15. A positioning system comprising:
a sensor;
a movement unit that moves the sensor; and
a processing unit,
wherein the sensor obtains a first image including a recognition target at a first time, obtains a second image including the recognition target at a second time later than the first time, and obtains a third image including the recognition target at a third time later than the second time,
wherein the processing unit determines first setting information of the sensor from the first image and the second image so as to satisfy a predetermined condition when the third image is obtained, and
wherein the first setting information includes a dimension of the third image and a frame rate at the time of obtaining the third image.

16. The positioning system according to claim 15, wherein the processing unit obtains the dimension of the third image, using a predicted value of dimension of the recognition target in the third image and a predetermined coefficient.

17. The positioning system according to claim 16,
wherein the dimension of the third image includes a dimension in a first direction and a second dimension in a direction orthogonal to the first direction, and
wherein the processing unit obtains the frame rate, using the second dimension and second setting information of the sensor.

18. The positioning system according to claim 17, wherein the second setting information includes an exposure time of the sensor, a transfer time of a head portion of the sensor, a transfer time which is increased per line of the sensor, a number of bits of a gradation value of the sensor, and a transfer time per bit of the sensor.

19. The positioning system according to claim 18,
wherein the predetermined condition includes a required value of the frame rate, and
wherein the frame rate is less than the required value.

20. The positioning system according to claim 19, wherein the predetermined condition includes a lower limit value of the predetermined coefficient.

21. (canceled)

22. (canceled)

23. (canceled)

24. (canceled)

25. (canceled)

26. (canceled)

27. (canceled)

28. (canceled)
